(19) United States
(12) Patent Application Publication
(10) Pub. No.: US 2023/0384139 A1
(43) Pub. Date: Nov. 30, 2023

(54) SHOWER TIME TRACKER AND INSTRUCTOR MECHANISM

(71) Applicants: Gaurang Suresh Gala, Millburn, NJ (US); Aneri Gaurang Gala, Millburn, NJ (US)

(72) Inventors: Gaurang Suresh Gala, Millburn, NJ (US); Aneri Gaurang Gala, Millburn, NJ (US)

(21) Appl. No.: 18/202,239

(22) Filed: May 25, 2023

Related U.S. Application Data
(60) Provisional application No. 63/345,516, filed on May 25, 2022.

(51) Int. Cl. G01F 15/063; A47K 3/28

(52) U.S. Cl. CPC G01F 15/063; A47K 3/281

(57) ABSTRACT

An object of the invention is to save water wastage. Another object of the invention is to track shower time. Yet another object of the invention is to inculcate better habits in humans. According to this invention, there is provided a shower time tracker and instructor mechanism, to be used in relation to a shower, said mechanism comprising: a synchronizer; a first display configured to be coupled with said synchronizer, said first display comprising parts of a body, to display various body parts correlative to pre-set combinations of sensed quantum, sensed flow rate, and/or sensed time; and a rule engine configured to determine rules of display correlative to various pre-set combinations of sensed quantum, sensed flow rate, and/or sensed time is correlative with a body part, on the first display.

### RELATED APPLICATIONS

This application claims priority under 35 U.S.C. § 119 to co-pending U.S. Provisional Application 63/345,516, filed May 25, 2022 and incorporated by reference herein in its entirety.

### FIELD

The invention relates to the field of electro-mechanical engineering. Particularly, this invention relates to a shower time tracker and instructor mechanism.

### BACKGROUND

Water plays a big role in supporting human, animal, and plant communities.

Clean freshwater is an essential ingredient for a healthy human life, but 1.1 billion people lack access to water and 2.7 billion experience water scarcity at least one month a year. By 2025, two-thirds of the world's population may be facing water shortages.

Without water there would be no local business or industry. Fire-fighting, municipal parks, and public swimming pools all need lots of water. An array of pipes, canals, and pumping stations managed by our public water systems are needed to bring a reliable supply of water to our taps each day. 20% of daily household water usage comes from shower.

FIG. 1 shows that normal shower time, in USA, is about 8 minutes as per CDC. Each minute of shower uses about 2.5 gallons of water. If one showers daily, reducing shower time, even by a minute, can lead to saving of 2.5 gallons per day or about 75 gallons of water per month.

In April 2021, Western US states prepared for possible 1st Water Shortage Declaration. U.S. water officials are projecting the man-made lakes that store water used throughout the American West will fall to historically low levels and trigger an official shortage declaration for the first time.

Reinforcing better habits, at earlier ages, will help younger generations take quicker and shorter showers and, hopefully, they will be able to carry this habit as adults; thereby, leading in tremendous savings in water usage.

### SUMMARY

An object of the invention is to save water wastage. Another object of the invention is to track shower time. Yet another object of the invention is to inculcate better habits in humans.

According to this invention, there is provided a shower time tracker and instructor mechanism, to be used in relation to a shower, said mechanism comprising:
a synchronizer configured to synchronise a first timer correlative to flow rate of water being dispensed from said shower and a second timer correlative to said mechanism, the synchronizer being configured to sense time and to use sensed time and senses flow rate to compute quantum of flow of water being dispensed, preferably, through said shower;
a first display configured to be coupled with said synchronizer, said first display comprising parts of a body, in order to display various body parts correlative to pre-set combinations of sensed quantum, sensed flow rate, and/or sensed time; and
a rule engine configured to determine rules of display correlative to various pre-set combinations of sensed quantum, sensed flow rate, and/or sensed time is correlative with a body part, on the first display such that a person using this mechanism knows the amount of time and/or quantum of water to be used for that body part; thereby, imparting positive feedback, and tracking of activity, geared towards conscious consumption of water.

In at least an embodiment, said synchronizer being coupled with a flow rate monitor configured to sense, and record, flow rate (gallons per minute) and quantum of flow of water being dispensed, preferably, through a shower.

In at least an embodiment, said synchronizer being coupled with a timer configured to sense, and record, amount of time spent using water from the shower.

In at least an embodiment, said synchronizer being coupled with a flow rate monitor configured to sense, and record, flow rate (gallons per minute) and quantum of flow of water being dispensed, preferably, through a shower, said mechanism comprising a second display configured to be coupled with said flow rate monitor, said the second display comprising a reading-marked display to display consumption of water.

In at least an embodiment, said synchronizer being coupled with:
a flow rate monitor configured to sense, and record, flow rate (gallons per minute) and quantum of flow of water being dispensed, preferably, through a shower;
   a timer configured to sense, and record, amount of time spent using water from the shower; characterized in that,
   the flow rate monitor and the timer, of the shower, is coupled with this first display, in such a manner that, basis various combinations of quantum, flow rate, and/or time, as obtained from the flow rate monitor and/or the timer, a pre-defined portion of the first display provides a visual/audio/audio-visual alarm.

### BRIEF DESCRIPTION OF THE ACCOMPANYING DRAWINGS

FIG. 1 shows that normal shower time.

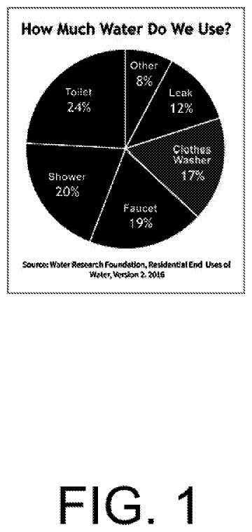

This invention will now be described in relation to the accompanying drawings, in which:

FIG. 2 illustrates a schematic of the mechanism of this invention.

### DETAILED DESCRIPTION

According to this invention, there is provided a shower time tracker and instructor mechanism.

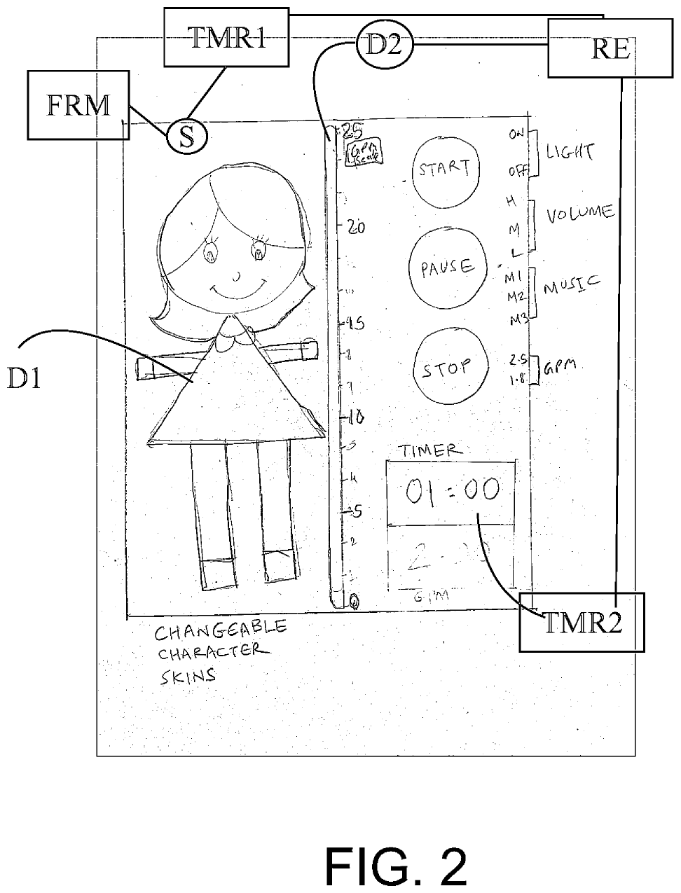

FIG. 2 illustrates a schematic of the mechanism of this invention.

In at least an embodiment, there is provided a flow rate monitor (FRM) configured to sense, and record, flow rate (gallons per minute) and quantum of flow of water being dispensed, preferably, through a shower (S).

In at least an embodiment, there is provided at least a set of timers (TMR1, TMR2) configured to sense, and record, amount of time spent using water from the shower (S). A first timer (TMR1) is correlative to flow rate of water being dispensed from said shower and a second timer (TMR2) is correlative to said mechanism. A synchronizer (SN) is configured to synchronise the first timer (TMR1) to the second timer (TMR2).

In at least an embodiment, a first display (D1) is configured to be coupled with the flow rate monitor (FRM) and the timer (TMR). Typically, the first display (D1) comprises a shape of a human figure with various body parts configured with different possible lighting mechanisms or alarm mechanisms.

In at least an embodiment, the flow rate monitor (FRM) and the timer (TMR), of the shower (S), is coupled with this first display (D1), in such a manner that, basis various combinations of quantum, flow rate, and/or time, as obtained from the flow rate monitor (FRM) and/or the timer (TMR), a pre-defined portion of the first display (D1) provides a visual/audio/audio-visual alarm. Each combination of quantum, flow rate, and/or time is correlated with a body part, on the first display (D1), such that a person using this mechanism knows the amount of time and/or quantum of water to be used for that body part; thereby, imparting positive feedback, and tracking of activity, geared towards conscious consumption of water.

In at least an embodiment, a second display (D2) is configured to be coupled with the flow rate monitor (FRM). Typically, the second display (D2) comprises a reading-marked display to display consumption of water. In preferred embodiments, if a shower uses 2.5 gallons per minute, the second display (D2) may show range of starting from 0 to 25 GPM scale covering about 0 to 10 minutes range. The markers could also comprise interesting facts (e.g. on the 4 gallon mark, there could small text “Water used by 1 person for entire day in Mali)

In at least an embodiment, a rule engine (RE) is configured to determine rules of display correlative to various pre-set combinations of sensed quantum, sensed flow rate, and/or sensed time is correlative with a body part, on the first display (D1) such that a person using this mechanism knows the amount of time and/or quantum of water to be used for that body part; thereby, imparting positive feedback, and tracking of activity, geared towards conscious consumption of water.

According to preferred embodiments, this mechanism can be a device which can be hung on a shower wall using a suction cup or an adhesive tape or any other available mechanism/s.

While this detailed description has disclosed certain specific embodiments for illustrative purposes, various modifications will be apparent to those skilled in the art which do not constitute departures from the spirit and scope of the invention as defined in the following claims, and it is to be distinctly understood that the foregoing descriptive matter is to be interpreted merely as illustrative of the invention and not as a limitation.

1. A shower time tracker and instructor mechanism, to be used in relation to a shower (S), said mechanism comprising:
a synchronizer (SN) configured to synchronise a first timer (TMR1) correlative to flow rate of water being dispensed from said shower and a second timer (TMR2) correlative to said mechanism, the synchronizer being configured to sense time and to use sensed time and senses flow rate to compute quantum of flow of water being dispensed, preferably, through said shower (S);
a first display (D1) configured to be coupled with said synchronizer, said first display (D1) comprising parts of a body, in order to display various body parts correlative to pre-set combinations of sensed quantum, sensed flow rate, and/or sensed time; and
a rule engine (RE) configured to determine rules of display correlative to various pre-set combinations of sensed quantum, sensed flow rate, and/or sensed time is correlative with a body part, on the first display (D1) such that a person using this mechanism knows the amount of time and/or quantum of water to be used for that body part; thereby, imparting positive feedback, and tracking of activity, geared towards conscious consumption of water.

2. The shower time tracker and instructor mechanism as claimed in claim 1 wherein, said synchronizer being coupled with a flow rate monitor (FRM) configured to sense, and record, flow rate (gallons per minute) and quantum of flow of water being dispensed, preferably, through a shower (S).

3. The shower time tracker and instructor mechanism as claimed in claim 1 wherein, said synchronizer being coupled with a timer (TMR) configured to sense, and record, amount of time spent using water from the shower (S).

4. The shower time tracker and instructor mechanism as claimed in claim 1 wherein, said synchronizer being coupled with a flow rate monitor (FRM) configured to sense, and record, flow rate (gallons per minute) and quantum of flow of water being dispensed, preferably, through a shower (S), said mechanism comprising a second display (D2) configured to be coupled with said flow rate monitor (FRM), said the second display (D2) comprising a reading-marked display to display consumption of water.

5. The shower time tracker and instructor mechanism as claimed in claim 1 wherein, said synchronizer being coupled with:
a flow rate monitor (FRM) configured to sense, and record, flow rate (gallons per minute) and quantum of flow of water being dispensed, preferably, through a shower (S);
a timer (TMR) configured to sense, and record, amount of time spent using water from the shower (S); characterized in that,
the flow rate monitor (FRM) and the timer (TMR), of the shower (S), is coupled with this first display (D1), in such a manner that, basis various combinations of quantum, flow rate, and/or time, as obtained from the flow rate monitor (FRM) and/or the timer (TMR), a pre-defined portion of the first display (D1) provides a visual/audio/audio-visual alarm.
